(19) United States
(12) Patent Application Publication
(10) Pub. No.: US 2005/0136291 A1
(43) Pub. Date: Jun. 23, 2005

(54) Magnetic recording medium, recording method and magnetic storage apparatus

(75) Inventors: Iwao Okamoto, Higashine (JP); Hisashi Umeda, Higashine (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/975,936

(22) Filed: Oct. 28, 2004

(30) Foreign Application Priority Data
Dec. 19, 2003 (JP) 2003-422800

(51) Int. Cl. G11B 5/72

(52) U.S. Cl. 428/695

(57) ABSTRACT

A magnetic recording medium is provided with first and second ferromagnetic layers which are exchange-coupled via a first nonmagnetic coupling layer and have mutually parallel magnetizations. The second ferromagnetic layer and a magnetic layer are exchange-coupled via a second nonmagnetic coupling layer and have magnetizations which are mutually antiparallel. The first and second ferromagnetic layers and the magnetic layer respectively have dynamic coercivities Hc1′, Hc2′ and Hc3′ which satisfy a relationship Hc1′<Hc3′≦Hc2′ in a switching time region of a recording magnetic field.

### BACKGROUND OF THE INVENTION

This application claims the benefit of a Japanese Patent Application No. 2003-422800 filed Dec. 19, 2003, in the Japanese Patent Office, the disclosure of which is hereby incorporated by reference.

1. Field of the Invention

The present invention generally relates to magnetic recording media, recording methods and magnetic storage apparatuses, and more particularly to a magnetic recording medium provided with a magnetic layer which is exchange-coupled to another layer and is suited for high-density recording, a recording method for recording information on such a magnetic recording medium, and a magnetic storage apparatus which employs such a recording method.

2. Description of the Related Art

Recently, the recording densities of magnetic recording media have increased rapidly, even at a rate reaching 100% per year. However, in the popularly employed longitudinal (or in-plane) recording system, it is expected that a limit of the longitudinal recording density will be on the order of 100 Gb/in², because of problems associated with thermal stability of the magnetic recording medium. In order to reduce the medium noise in the high-density recording region, the size of crystal grain forming the magnetization unit is reduced, so as to reduce the zigzag of the boundary between the magnetization units, that is, the magnetization transition region. However, when the size of the crystal grain is reduced, the volume forming the magnetization unit decreases, to thereby cause the magnetization to decrease due to thermal instability. Accordingly, in order to achieve a high recording density exceeding 100 Gb/in², it is necessary to simultaneously reduce the medium noise and improve the thermal stability.

Magnetic recording media which simultaneously reduce the medium noise and improve the thermal stability have been proposed in Japanese Laid-Open Patent Applications No. 2001-056921 and No. 2001-056924, for example. FIG. 1 is a cross sectional view showing a part of a proposed magnetic recording medium 100. The proposed magnetic recording medium 100 shown in FIG. 1 includes an exchange layer structure provided on a substrate 105, and a magnetic layer 102 provided on the exchange layer structure. The exchange layer structure is made up of a ferromagnetic layer 101 provided on the substrate 105, and a nonmagnetic coupling layer 103 provided on the ferromagnetic layer 101. The ferromagnetic layer 101 and the magnetic layer 102 are exchange-coupled anti-ferromagnetically via the nonmagnetic coupling layer 103. The effective crystal grain volume becomes the sum of crystal grain volumes of the ferromagnetic layer 101 and the magnetic layer 102 which are exchange-coupled. Consequently, the thermal stability is greatly improved, and the medium noise can be reduced because the crystal grain size can further be reduced. By using the proposed magnetic recording medium 100, the thermal stability of the recorded (written) bits improve, and the medium noise is reduced, thereby enabling a highly reliable high-density recording.

In the proposed magnetic recording medium 100, the reproduced output is approximately proportional to a difference between the remanent magnetizations of the magnetic layer 102 and the ferromagnetic layer 101, because the magnetization directions of the magnetic layer 102 and the ferromagnetic layer 101 are mutually antiparallel. Hence, in order to obtain a reproduced output comparable to that obtained by the conventional magnetic recording medium having the magnetic layer with the single-layer structure, the magnetic layer 102 closer to a recording and/or reproducing magnetic head is set thicker than the ferromagnetic layer 101 which is further away from the magnetic head, and also thicker than the conventional magnetic layer having the single-layer structure, if materials having the same composition are used for the magnetic layer 102 and the ferromagnetic layer 101. However, when the proposed magnetic recording medium 100 has the magnetic layer 102 with such a thickness, there is a possibility of deteriorating the write performances, such as the overwrite performance and the Non-Linear-Transition-Shift (NLTS) performance, due to the increased thickness of the magnetic layer 102.

On the other hand, when a recording magnetic field is applied to the proposed magnetic recording medium 100 from the magnetic head at the time of the recording, the magnetization directions of the magnetic layer 102 and the ferromagnetic layer 101 align in the direction of the recording magnetic field and become mutually parallel. Thereafter, when the magnetic head moves and the recording magnetic field weakens, the magnetization direction of the ferromagnetic layer 101 switches in response to an exchange field of the magnetic layer 102 and the magnetization directions of the ferromagnetic layer 101 and the magnetic layer 102 become mutually antiparallel. However, in a vicinity of a magnetic pole of the magnetic head at a trailing edge along the moving direction of the magnetic head, the behaviors of the magnetic layer 102 and the ferromagnetic layer 101, such as the switching of the magnetization directions, immediately after switching the direction of the recording magnetic field, become complex due to the exchange field and the demagnetization field of each of the magnetic layer 102 and the ferromagnetic layer 101. With respect to the magnetic layer 102, the position, inclination and the like of the magnetization transition region may change and the NLTS performance may deteriorate, particularly due to the magnetic characteristics and the like of the ferromagnetic layer 101.

But if the thickness of the ferromagnetic layer 101 is simply increased to increase the effective crystal grain volume for the purposes of improving the thermal stability, the overwrite performance may deteriorate.

### SUMMARY OF THE INVENTION

Accordingly, it is a general object of the present invention to provide a novel and useful magnetic recording medium, recording method and magnetic storage apparatus, in which the problems described above are suppressed.

Another and more specific object of the present invention is to provide a magnetic recording medium, a recording method and a magnetic storage apparatus, which can realize satisfactory thermal stability of written bits, low medium noise and satisfactory write performances.

Still another object of the present invention is to provide a magnetic recording medium comprising a first ferromagnetic layer; a first nonmagnetic coupling layer disposed on the first ferromagnetic layer; a second ferromagnetic layer disposed on the first nonmagnetic coupling layer; a second nonmagnetic coupling layer disposed on the second ferromagnetic layer; and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, the first and second ferromagnetic layers and the magnetic layer respectively having dynamic coercivities Hc1′, Hc2′ and Hc3′ which satisfy a relationship Hc1′<Hc3′≦Hc2′ in a switching time region of a recording magnetic field. According to the magnetic recording medium of the present invention, it is possible to realize satisfactory thermal stability of written bits, low medium noise and satisfactory write performances.

A further object of the present invention is to provide a magnetic recording medium comprising a first ferromagnetic layer; a first nonmagnetic coupling layer disposed on the first ferromagnetic layer; a second ferromagnetic layer disposed on the first nonmagnetic coupling layer; a second nonmagnetic coupling layer disposed on the second ferromagnetic layer; and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, the first ferromagnetic layer being made of a CoCr alloy or a CoCrPt alloy, the second ferromagnetic layer and the magnetic layer being made of a CoCrPt alloy, the first and second ferromagnetic layers and the magnetic layer respectively having Pt contents Pt1, Pt2 and Pt3 satisfying a relationship Pt1<Pt3≦Pt2. According to the magnetic recording medium of the present invention, it is possible to realize satisfactory thermal stability of written bits, low medium noise and satisfactory write performances.

Another object of the present invention is to provide a magnetic recording medium comprising a first ferromagnetic layer; a first nonmagnetic coupling layer disposed on the first ferromagnetic layer; a second ferromagnetic layer disposed on the first nonmagnetic coupling layer; a second nonmagnetic coupling layer disposed on the second ferromagnetic layer; and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, a magnetization direction of the magnetic layer switching before a magnetization direction of the second ferromagnetic layer when a recording magnetic field for switching the magnetization direction of the magnetic field is applied to the magnetic recording medium. According to the magnetic recording medium of the present invention, it is possible to realize satisfactory thermal stability of written bits, low medium noise and satisfactory write performances.

Still another object of the present invention is to provide a magnetic storage apparatus comprising at least one magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, the first and second ferromagnetic layers and the magnetic layer respectively having dynamic coercivities Hc1′, Hc2′ and Hc3′ which satisfy a relationship Hc1′<Hc3′≦Hc2′ in a switching time region of a recording magnetic field; and a head to record information on and/or reproduce information from the magnetic recording medium. According to the magnetic storage apparatus of the present invention, it is possible to realize satisfactory thermal stability of written bits, low medium noise and satisfactory write performances.

Still another object of the present invention is to provide a magnetic storage apparatus comprising at least one magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, the first ferromagnetic layer being made of a CoCr alloy or a CoCrPt alloy, the second ferromagnetic layer and the magnetic layer being made of a CoCrPt alloy, the first and second ferromagnetic layers and the magnetic layer respectively having Pt contents Pt1, Pt2 and Pt3 satisfying a relationship Pt1<Pt3≦Pt2; and a head to record information on and/or reproduce information from the magnetic recording medium. According to the magnetic storage apparatus of the present invention, it is possible to realize satisfactory thermal stability of written bits, low medium noise and satisfactory write performances.

A further object of the present invention is to provide a magnetic storage apparatus comprising at least one magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, a magnetization direction of the magnetic layer switching before a magnetization direction of the second ferromagnetic layer when a recording magnetic field for switching the magnetization direction of the magnetic field is applied to the magnetic recording medium; and a head to record information on and/or reproduce information from the magnetic recording medium. According to the magnetic storage apparatus of the present invention, it is possible to realize satisfactory thermal stability of written bits, low medium noise and satisfactory write performances.

Another object of the present invention is to provide a recording method for magnetically recording information on a magnetic recording medium by applying a recording magnetic field on the magnetic recording medium, the magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, the recording method comprising the steps of switching a magnetization direction of the magnetic layer; and switching magnetization directions of the first and second ferromagnetic layers by applying the recording magnetic field to make the magnetizations of the first and second ferromagnetic layers mutually parallel and thereafter removing the recording magnetic field. According to the recording method of the present invention, it is possible to realize satisfactory thermal stability of written bits, low medium noise and satisfactory write performances.

Still another object of the present invention is to provide a recording method for magnetically recording information on a magnetic recording medium by applying a recording magnetic field on the magnetic recording medium, the magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, the first and second ferromagnetic layers being exchange-coupled, the second ferromagnetic layer and the magnetic layer being exchange-coupled, the first and second ferromagnetic layers having magnetizations which are mutually parallel in a state where no external magnetic field is applied thereto, the second ferromagnetic layer and the magnetic layer having magnetizations which are mutually antiparallel in the state where no external magnetic field is applied thereto, the recording method comprising the steps of switching a magnetization direction of the magnetic layer; and satisfying a relationship Hh3+HE 3−Hc3′>Hh2+HE2−Hc2′>0 when switching a direction of the recording magnetic field, where Hc2′ denotes a dynamic coercivity of the second ferromagnetic layer, Hc3′ denotes a dynamic coercivity of the magnetic layer, HE2 denotes an exchange field applied to the second ferromagnetic layer due to exchange fields of the first ferromagnetic layer and the magnetic layer, HE3 denotes an exchange field of the second ferromagnetic layer applied to the magnetic layer, Hh2 denotes a recording magnetic field at the second ferromagnetic layer, and Hh3 denotes a recording magnetic field at the magnetic layer. According to the recording method of the present invention, it is possible to realize satisfactory thermal stability of written bits, low medium noise and satisfactory write performances.

A further object of the present invention is to provide a magnetic recording medium comprising a first ferromagnetic layer; a first nonmagnetic coupling layer disposed on the first ferromagnetic layer; a second ferromagnetic layer disposed on the first nonmagnetic coupling layer; a second nonmagnetic coupling layer disposed on the second ferromagnetic layer; and a magnetic layer disposed on the second nonmagnetic coupling layer, the first and second ferromagnetic layers being exchange-coupled and having mutually parallel magnetizations, the second ferromagnetic layer and the magnetic layer being exchange-coupled and having magnetizations which are mutually antiparallel, the first and second ferromagnetic layers and the magnetic layer respectively having dynamic coercivities Hc1′, Hc2′ and Hc3′ which satisfy a relationship Hc1′<Hc3′≦Hc2′ in a switching time region of a recording magnetic field. According to the magnetic recording medium of the present invention, it is possible to realize satisfactory thermal stability of written bits, low medium noise and satisfactory write performances.

Other objects and further features of the present invention will be apparent from the following detailed description when read in conjunction with the accompanying drawings.

### BRIEF DESCRIPTION OF THE DRAWINGS

FIG. 1 is a cross sectional view showing a part of a proposed magnetic recording medium;

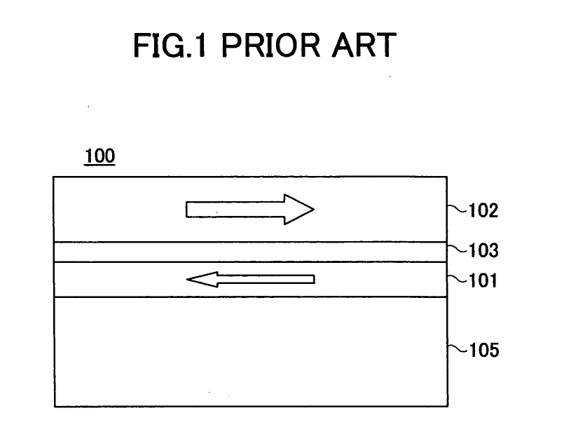

FIG. 2 is a cross sectional view showing a part of a first embodiment of a magnetic recording medium according to the present invention;

FIG. 3 is a diagram showing a static magnetic characteristic and magnetization states of the first embodiment of the magnetic recording medium;

FIG. 4 is a diagram showing relationships of a dynamic coercivity and a static coercivity, and a magnetic field switching time and a magnetization switching time of the first embodiment of the magnetic recording medium;

FIGS. 5A through 5F are diagrams for explaining a first embodiment of a recording method according to the present invention;

FIG. 6 is a cross sectional view showing a part of a first embodiment of a magnetic storage apparatus according to the present invention; and

FIG. 7 is a plan view showing a part of the first embodiment of the magnetic storage apparatus.

### DESCRIPTION OF THE PREFERRED EMBODIMENTS

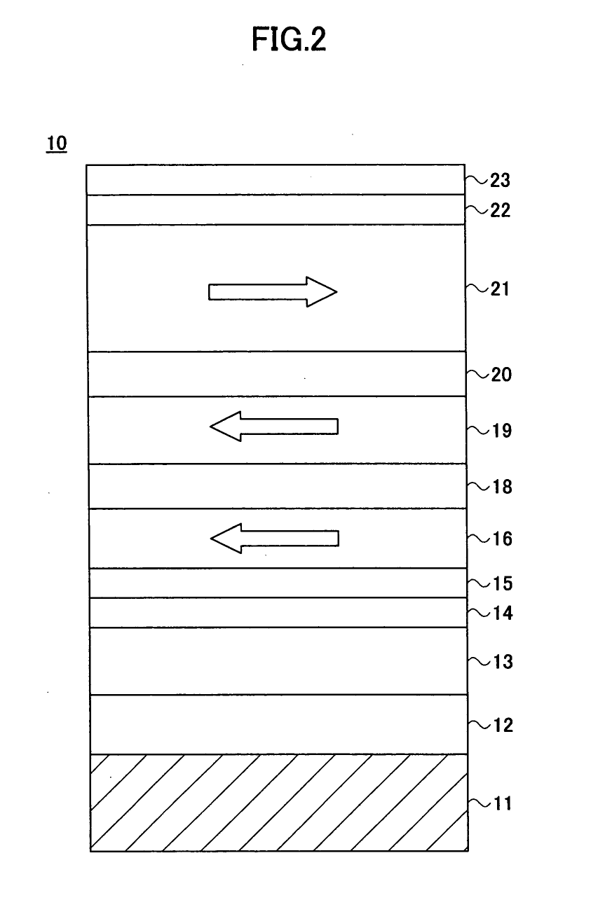

A description will be given of embodiments of a magnetic recording medium, a recording method and a magnetic storage apparatus according to the present invention, by referring to FIGS. 2 through 7.

FIG. 2 is a cross sectional view showing a part of a first embodiment of the magnetic recording medium according to the present invention. A magnetic recording medium 10 shown in FIG. 2 includes a substrate 11, and a stacked structure provided on the substrate 11. The stacked structure includes a first seed layer 12, a second seed layer 13, an underlayer 14, a nonmagnetic intermediate layer 15, a first ferromagnetic layer 16, a first nonmagnetic coupling layer 18, a second ferromagnetic layer 19, a second nonmagnetic coupling layer 20, a magnetic layer 21, a protection layer 22, and a lubricant layer 23 which are successively stacked in this order. The second ferromagnetic layer 19 and the magnetic layer 21 are antiferromagnetically exchange-coupled via the second nonmagnetic coupling layer 20. In addition, the first ferromagnetic layer 16 and the second ferromagnetic layer 19 are ferromagnetically exchange-coupled via the first nonmagnetic coupling layer 18.

The substrate 11 may be formed by a disk-shaped plastic substrate, glass substrate, NiP-plated Al alloy substrate, Si substrate and the like, for example. The substrate 11 may also be formed by tape-shaped plastic films made of PET, PEN, polyimide and the like. The substrate 11 may or may not be textured. In a case where the magnetic recording medium 10 is a magnetic disk, a texturing process is carried out in a circumferential direction of the magnetic disk, that is, in a direction in which a track on the magnetic disk extends.

The first seed layer 12 may be made of a nonmagnetic material such as NiP, CoW and CrTi. The first seed layer 12 may or may not be textured. In a case where the first seed layer 12 is made of an amorphous material such as NiP, the first seed layer 12 is preferably oxidized, so that the in-plane orientation of the c-axis improves for the first ferromagnetic layer 16, the second ferromagnetic layer 19 and the magnetic layer 21. Of course, a known material which improves the c-axis orientation may be used for the first seed layer 12 in place of NiP.

The second seed layer 13 may be made of an amorphous material such as NiP, CoW and CrTi, or an alloy having a B2 structure such as AlRu, NiAl and FeAl. In a case where the second seed layer 13 is made of the amorphous material and the underlayer 14 is made of an alloy having the B2 structure, the orientation of the (001) face or (112) face of the underlayer 14 is improved. The second seed layer 13 may or may not be textured. In a case where the magnetic recording medium 10 is the magnetic disk, the texturing process is carried out in the circumferential direction of the magnetic disk, that is, in the direction in which the track on the magnetic disk extends.

The underlayer 14 may be made of Cr or a Cr alloy such as CrMo, CrW, CrV, CrB and CrMoB, or an alloy having a B2 structure such as AlRu, NiAl and FeAl. When the underlayer 14 is epitaxially grown on the second seed layer 13, the underlayer 14 shows a good orientation of the (001) face or the (112) face in the growth direction if the alloy having the B2 structure is used for the underlayer 14, and shows a good orientation of the (002) face in the growth direction if the Cr or Cr alloy is used for the underlayer 14. The underlayer 14 may have a multi-layer structure made up of a plurality of stacked layers formed by the Cr or Cr alloy and the alloy having the B2 structure. The orientation of the underlayer 14 itself is improved by employing the multi-layer structure for the underlayer 14. In addition, by employing the multi-layer structure for the underlayer 14, a good epitaxial growth of the nonmagnetic intermediate layer 15 can be achieved, and the orientations of the first ferromagnetic layer 16, the second ferromagnetic layer 19 and the magnetic layer 21 can further be improved.

The nonmagnetic intermediate layer 15 may be made of a nonmagnetic alloy having an hcp structure and obtained by adding M to a CoCr alloy, where M denotes an element selected from Pt, B, Mo, Nb, Ta, W and Cu or an alloy thereof. The nonmagnetic intermediate layer 15 has a thickness in a range of 1 nm to 5 nm. The nonmagnetic intermediate layer 15 is epitaxially grown to inherit the crystal properties and crystal grain sizes of the underlayer 14. Hence, the nonmagnetic intermediate layer 15 improves the crystal properties of the first ferromagnetic layer 16, the second ferromagnetic layer 19 and the magnetic layer 21 which are epitaxially grown afterwards, reduces a distribution width of the crystal grain (magnetic grain) sizes, and promotes the in-plane orientation of the c-axis. The in-plane orientation refers to the orientation in a direction parallel to the substrate surface. The nonmagnetic intermediate layer 15 may have a multi-layer structure which is made up of a plurality of layers which are made of the above described alloys and stacked. Therefore, the nonmagnetic intermediate layer 15 improves the orientation of the first ferromagnetic layer 16, the second ferromagnetic layer 19 and the magnetic layer 21.

The lattice constant of the nonmagnetic intermediate layer 15 may be made slightly different, that is, a several % different, from the lattice constant of the first ferromagnetic layer 16, so as to generate an internal stress in the in-plane direction at an interface of the nonmagnetic intermediate layer 15 and the first ferromagnetic layer 16 or within the first ferromagnetic layer 16. In this case, it is possible to increase the static coercivity of the first ferromagnetic layer 16.

As will be described later, a static magnetic characteristic of the magnetic recording medium 10 may be measured by a Vibration Sample Magnetometer (VSM) or the like, and the measuring time of one loop is on the order of approximately several minutes. A time required to switch the direction of the external magnetic field is on the order of approximately several seconds. Such a time required to switch the direction of the external magnetic field will hereinafter be referred to as a “magnetic field switching time”, and the coercivity Hc for a case where the magnetic field switching time is on the order of seconds or greater is referred to as a static coercivity Hc.

On the other hand, the magnetic field switching time at the time of the recording when the magnetic head applies the magnetic field on the magnetic recording medium 10 is on the sub-nano-second to approximately one nano-second order. When switching the magnetic field in such a short magnetic field switching time, a force (for example, a viscous force) acts in a direction interfering with the magnetization motion, and a large magnetic field needs to be applied in order to switch the magnetization direction. In other words, the coercivity Hc increases, and this coercivity Hc which increases in such a manner is referred to as a dynamic coercivity Hc′.

The first ferromagnetic layer 16 may be made of Co, Ni, Fe, Co alloy, Ni alloy, Fe alloy and the like. It is particularly preferable to use CoCrTa, CoCrPt or alloys thereof for the first ferromagnetic layer 16. The preferable CoCrPt alloy may be obtained by adding an element selected from B, Mo, Nb, Ta, W and Cu or an alloy thereof. The first ferromagnetic layer 16 has a thickness in a range of 1 nm to 10 nm. The first ferromagnetic layer 16 is epitaxially grown in a (11-20) direction on the nonmagnetic intermediate layer 15, where “(11-20)” denotes (“1” “1” “2 bar” “0”), and the c-axis is orientated in the in-plane direction and the axis of easy magnetization matches the in-plane direction.

The first ferromagnetic layer 16 has a dynamic coercivity lower than that of the second ferromagnetic layer 19. Hence, the magnetization direction of the first ferromagnetic layer 16 is more easily switched than that of the second ferromagnetic layer 19 in response to a small magnetic field which is applied thereto, such as a recording magnetic field and an exchange field. On the other hand, by providing the first ferromagnetic layer 16, this first ferromagnetic layer 16 becomes indirectly exchange-coupled to the magnetic layer 21 via the second ferromagnetic layer 19, to thereby increase the exchange-coupling volume and improve the thermal stability. Accordingly, compared to a conventional magnetic recording medium provided with a magnetic layer having the single-layer structure with a thickness equal to a total thickness of the first ferromagnetic layer 16 in place of the exchange-coupled structure, the second ferromagnetic layer 19 and the magnetic layer 21, the magnetic recording medium 10 can obtain approximately the same thermal stability. Moreover, since the dynamic coercivity of the first ferromagnetic layer 16 which is further away from a magnetic head than the second ferromagnetic layer 19 and the magnetic layer 21 is set lower than the dynamic coercivities of the second ferromagnetic layer 19 and the magnetic layer 21, the magnetic recording medium 10 can improve the overwrite performance compared to the above conventional magnetic recording medium.

The first nonmagnetic coupling layer 18 may be made of Ru, Rh, Ir, Ru alloy, Rh alloy, Ir alloy and the like, for example. Rh and Ir have an fcc structure, while Ru has the hcp structure. The lattice constant a=0.25 nm for the CoCrPt alloy used for the first ferromagnetic layer 16, while the lattice constant a=0.27 nm for the Ru used for the first nonmagnetic coupling layer 18. Hence, it is preferable to use Ru or Ru alloy for the first nonmagnetic coupling layer 18 so as to have the lattice parameter a close to that of the first ferromagnetic layer 16. The Ru alloy used for the first nonmagnetic coupling layer 18 may preferably be an alloy of Ru and an element selected from Ti, V, Cr, Mn, Fe, Co, Ni, Nb, Mo, Rh, Pd, Ta, W, Re, Os, Ir and Pt or an alloy thereof. It is preferable to use a Ru alloy Ru₁₀₀₋ₓCoₓ for the first nonmagnetic coupling layer 18, where x is greater than 0 at. % and less than or equal to 60 at. %, and x is more preferably greater than 0 at. % and less than or equal to 40 at. %. By using such a Ru alloy for the first nonmagnetic coupling layer 18, it is possible to expand a thickness range of the first nonmagnetic coupling layer 18 which ferromagnetically couples the first ferromagnetic layer 16 and the second ferromagnetic layer 19 towards the thicker side.

The Rh alloy used for the first nonmagnetic coupling layer 18 may preferably be an alloy of Rh and an element selected from Ti, V, Cr, Mn, Fe, Co, Ni, Cu, Zr, Nb, Mo, Ru, Pd, Ag, Sb, Hf, Ta, W, Re, Os, Ir and Pt or an alloy thereof. The Ir alloy used for the first nonmagnetic coupling layer 18 may preferably be an alloy of Ir and an element selected from Al, Ti, V, Cr, Mn, Fe, Co, Ni, Cu, Nb, Mo, Tc, Ru, Rh, Pd, Ta, W, Re and Os or an alloy thereof.

In a case where the Ru is used for the first nonmagnetic coupling layer 18, the first nonmagnetic coupling layer 18 preferably has a thickness in a range of 0.1 nm to 0.45 nm. In a case where a Ru alloy such as RuCo is used for the first nonmagnetic coupling layer 18, the first nonmagnetic coupling layer 18 preferably has a thickness in a range of 0.1 nm to 0.95 nm. Hence, it is preferable to appropriately select the thickness range of the first nonmagnetic coupling layer 18 depending on the alloy material and the content of the added element within the alloy material used for the first nonmagnetic coupling layer 18, so that the first ferromagnetic layer 16 and the second ferromagnetic layer 19 become ferromagnetically coupled. By setting such a thickness range for the first nonmagnetic coupling layer 18, it is possible to ferromagnetically exchange-couple the first ferromagnetic layer 16 and the second ferromagnetic layer 19, and make the magnetization directions of the first ferromagnetic layer 16 and the second ferromagnetic layer 19 mutually parallel in a state where no external magnetic field is applied thereto. In addition, from the point of view of expanding the thickness range of the first nonmagnetic coupling layer 18 which ferromagnetically couples the first ferromagnetic layer 16 and the second ferromagnetic layer 19, the first nonmagnetic coupling layer 18 is preferably made of RuCo to enable such an expansion of the thickness range. From the point of view of obtaining a large exchange-coupling strength between the first ferromagnetic layer 16 and the second ferromagnetic layer 19, the nonmagnetic coupling layer 18 preferably has a thickness in a range of 0.2 nm to 0.8 nm. Moreover, in a case where Ru₈₀CO₂₀ is used for the nonmagnetic coupling layer 18, the nonmagnetic coupling layer 18 preferably has a thickness in a range of 0.2 nm to 0.7 nm.

The first nonmagnetic coupling layer 18 may be formed by sputtering, vacuum deposition, Chemical Vapor Deposition (CVD) and the like. It is possible to employ an Ion Cluster Beam (ICB) to form the first nonmagnetic coupling layer 18 in order to suppress the thickness inconsistency for the entire substrate area. When the ICB is employed, the thickness inconsistency of the first nonmagnetic coupling layer 18 is suppressed because the kinetic energy reaching the surface and the amount of deposition can be controlled satisfactorily. Furthermore, by employing the ICB to form the first nonmagnetic coupling layer 18, it may be regarded that the minimum thickness of the Ru layer or Ru alloy layer forming the first nonmagnetic coupling layer 18 can be controlled to approximately 0.2 nm.

The second ferromagnetic layer 19 may be made of Co, Ni, Fe, Co alloy, Ni alloy, Fe alloy and the like, similarly as in the case of the first ferromagnetic layer 16. It is particularly preferable to use CoCrTa, CoCrPt or alloys thereof for the second ferromagnetic layer 19. The preferable CoCrPt alloy may be obtained by adding an element selected from B, Mo, Nb, Ta, W and Cu or an alloy thereof.

In this embodiment, the Pt content of the material or alloy used for the second ferromagnetic layer 19 is larger than those of the first ferromagnetic layer 16 and the magnetic layer 21. In other words, a Pt content Pt1 of the first ferromagnetic layer 16, a Pt content Pt2 of the second ferromagnetic layer 19 and a Pt content Pt3 of the magnetic layer 21 satisfy a relationship Pt1<Pt3≦Pt2. In addition, a dynamic coercivity Hc1′of the first ferromagnetic layer 16, a dynamic coercivity Hc2′ of the second ferromagnetic layer 19 and a dynamic coercivity Hc3′ of the magnetic layer 21 satisfy a relationship Hc1′<Hc3′≦Hc2′. For example, the Pt content Pt3 of the CoCrPtB alloy used for the magnetic layer 21 is 9 at. %, the Pt content Pt1 of the CoCrPtB alloy used for the first ferromagnetic layer 16 is 2 at. %, and the Pt content Pt2 of the CoCrPtB alloy used for the second ferromagnetic layer 19 is 15 at. %. In this case, the dynamic coercivity Hc2′ of the second ferromagnetic layer 19 may be increased.

It is not essential for the layer forming the first ferromagnetic layer 16 to include Pt. By satisfying at least one of the above described relationships, it is possible to reduce the dynamic coercivity Hc1′ of the first ferromagnetic layer 16, and to easily and quickly switch the magnetization direction of the first ferromagnetic layer 16 in the same direction as the magnetization direction of the second ferromagnetic layer 19 by the exchange field of the second ferromagnetic layer 19 after the recording magnetic field is removed. The quick switching of the magnetization direction of the first ferromagnetic layer 16 occurs within a time on the order of approximately 1 msec. This time in which the magnetization direction of the first ferromagnetic layer 16 is switched is shorter than a time required for the magnetic disk to undergo 1 revolution, in the case where the magnetic recording medium 10 is the magnetic disk. Therefore, by satisfying at least one of the above described relationships, the magnetization state stabilizes while the magnetic disk undergoes 1 revolution after the recording, and the reproduced output of the magnetic head can be stabilized. Of course, the above described relationship of the dynamic coercivities Hc1′, Hc2′ and Hc3′ of the first ferromagnetic layer 16, the second ferromagnetic layer 19 and the magnetic layer 21 may be satisfied by appropriately adjusting contents of an element other than Pt in the alloys forming the first ferromagnetic layer 16, the second ferromagnetic layer 19 and the magnetic layer 21.

In order to satisfy the relationship Hc1′<Hc3′≦Hc2′ among the dynamic coercivity Hc1′ of the first ferromagnetic layer 16, the dynamic coercivity Hc2′ of the second ferromagnetic layer 19 and the dynamic coercivity Hc3′ of the magnetic layer 21, an anisotropic field Hk1 of the first ferromagnetic layer 16, an anisotropic field Hk2 of the second ferromagnetic layer 19 and an anisotropic field Hk3 of the magnetic layer 21 may be set to satisfy a relationship Hk1<Hk3≦Hk2. The following relationship between the dynamic coercivity Hc′ and the anisotropic field Hk is described in H. N. Bertram et al., J. Appl. Phys., vol. 85, No. 8, pp. 4991 (1999), where fₒ denotes an attempt frequency, Kᵤ denotes an anisotropy constant, V denotes a volume of a magnetic unit, k_{B} denotes the Boltzmann's constant, and T denotes the absolute temperature.
Hc′=0.474 Hk[1-1.55{(k_{B}T/K_{U}V)−ln (fₒt/ln2)/2}]^{2/3}

Hence, it may be regarded that the magnetic field switching time t=10⁻⁹/ln2 seconds and the anisotropic field Hk and the dynamic coercivity Hc′ are proportional. For this reason, by setting the first ferromagnetic layer 16, the second ferromagnetic layer 19 and the magnetic layer 21 to satisfy the relationship Hk1<Hk3≦Hk2, the first ferromagnetic layer 16, the second ferromagnetic layer 19 and the magnetic layer 21 can be set to satisfy the relationship Hc1′<Hc3′≦Hc2′.

The second ferromagnetic layer 19 has a thickness in a range of 0.2 nm to 3.0 nm. By setting the thickness of the second ferromagnetic layer 19 within such a range, it is possible to reduce a static coercivity Hc2 of the second ferromagnetic layer 19, and a relationship Hc3>Hc2 can be satisfied between the static coercivity Hc3 of the magnetic layer 21 and the static coercivity of the second ferromagnetic layer 19. From the point of view of obtaining a satisfactory overwrite performance, it is preferable for the thickness of the second ferromagnetic layer 19 to be within a range of 0.5 nm to 2.0 nm as long as a relationship Hc3′≦Hc2′ is satisfied between the dynamic coercivity Hc3′ of the magnetic layer 21 and the dynamic coercivity Hc2′ of the second ferromagnetic layer 19. Since the second ferromagnetic layer 19 is thin, the overwrite performance is maintained approximately the same or only a slight deterioration will occur if any, even if the dynamic coercivity Hc2′ is greatly increased, compared to a case where the dynamic coercivity Hc2′ is relatively small.

The second nonmagnetic coupling layer 20 may be made of a material similar to that used for the first nonmagnetic coupling layer 18 described above. The second nonmagnetic coupling layer 20 has a thickness in a range of 0.5 nm to 1.4 nm, and the thickness may be appropriately selected depending on the material used for the second nonmagnetic coupling layer 20. By setting such a thickness range for the second nonmagnetic coupling layer 20, it is possible to antiferromagnetically exchange-couple the second ferromagnetic layer 19 and the magnetic layer 21, and make the magnetization directions of the second ferromagnetic layer 19 and the magnetic layer 21 mutually antiparallel in a state where no external magnetic field is applied thereto. In a case where the Ru is used for the second nonmagnetic coupling layer 20, the second nonmagnetic coupling layer 20 preferably has a thickness in a range of 0.5 nm to 0.9 nm. In a case where a Ru alloy such as RuCo is used for the second nonmagnetic coupling layer 20, the second nonmagnetic coupling layer 20 preferably has a thickness in a range of 1.0 nm to 1.4 nm. From the point of view of expanding the thickness range of the second nonmagnetic coupling layer 20 which antiferromagnetically couples the second ferromagnetic layer 18 and the magnetic layer 21, the second nonmagnetic coupling layer 20 is preferably made of RuCo to enable such an expansion of the thickness range.

The magnetic layer 21 may be made of Co, Ni, Fe, Co alloy, Ni alloy, Fe alloy and the like, similarly as in the case of the first ferromagnetic layer 16 and the second ferromagnetic layer 19. It is particularly preferable to use CoCrTa, CoCrPt or alloys thereof for the magnetic layer 21. The preferable CoCrPt alloy may be obtained by adding an element selected from B, Mo, Nb, Ta, W and Cu or an alloy thereof. The magnetic layer 21 has a thickness in a range of 5 nm to 30 nm. Since the layers of the stacked structure, from the first seed layer 12 to the magnetic layer 21, are grown epitaxially, the magnetic layer 21 has satisfactory crystal properties and finely controlled crystal grain diameters. For this reason, the medium noise of the magnetic recording medium 10 can be reduced.

It is preferable that a saturation magnetization Ms1 and a thickness t1 of the first ferromagnetic layer 16, a saturation magnetization Ms2 and a thickness t2 of the second ferromagnetic layer 19, and a saturation magnetization Ms3 and a thickness t3 of the magnetic layer 21 satisfy the following relationship.
(Ms1×t1+Ms2×t2)<(Ms3×t3)

By satisfying this relationship of the saturation magnetizations Ms1, Ms2 and Ms3 and the thicknesses t1, t2 and t3 of the first ferromagnetic layer 16, the second ferromagnetic layer 19 and the magnetic layer 21, the magnetic layer 21 closest to the magnetic head bears the net remanent magnetization and thickness product, and it becomes possible to more accurately record the information in the magnetic layer 21 in correspondence with the switching positions of the recording magnetic field of the magnetic head. It is possible to set the relationship to (Ms1×t1+Ms2×t2)>(Ms3×t3), but in this case, the first ferromagnetic layer 16 and the second ferromagnetic layer 19 which are further away from the magnetic head than the magnetic layer 21 bear the remanent magnetization and thickness product. Consequently, it becomes more difficult to accurately record the information in the magnetic layer 21 in correspondence with the switching positions of the recording magnetic field of the magnetic head, and the reproduced output of the magnetic head decreases because the first ferromagnetic layer 16 and the second ferromagnetic layer 19 are further away from the magnetic head than the magnetic layer 21.

As described above, the dynamic coercivities Hc2′ and Hc3′ of the second ferromagnetic layer 19 and the magnetic layer 21 satisfy the relationship Hc2′≧Hc3′. By satisfying this relationship Hc2′≧Hc3′, the magnetization direction of the magnetic layer 21 switches before the magnetization direction of the second ferromagnetic layer 19, in response to the switching of the recording magnetic field of the magnetic head. Accordingly, a magnetization transition region which matches the switching timing of the recording magnetic field is formed in the magnetic layer 21, and the NLTS can be reduced.

The protection layer 22 may be made of diamond-like carbon, carbon nitride, amorphous carbon and the like. The protection layer 22 has a thickness in a range of 0.5 nm to 10 nm, and preferably in a range of 0.5 nm to 5 nm.

The lubricant layer 23 may be made of an organic liquid lubricant having perfluoropolyether as a main chain and —OH, benzene ring or the like as the terminal functional group. More particularly, ZDol manufactured by Monte Fluos (terminal functional group: —OH), AM3001 manufactured by Ausimonoto (terminal functional group: benzene ring), Z25 manufactured by Monte Fluos, and the like, with a thickness in a range of 0.5 nm to 3.0 nm, may be used for the lubricant layer 23. The lubricant may be appropriately selected depending on the material used for the protection layer 22.

The layers 12 through 16 and 18 through 22 may be successively formed on the substrate 11 by sputtering, vacuum deposition and the like. On the other hand, the lubricant layer 23 may be formed by dipping, spin-coating and the like. In a case where the magnetic recording medium 10 has a tape-shape, the lubricant layer 23 may be formed by die-coating, dipping and the like.

Next, a description will be given of a case where this embodiment is applied to the magnetic disk. First, a NiP first seed layer 12 having a thickness of 25 nm was formed on a glass substrate 11, and exposed to the atmosphere to oxidize the NiP first seed layer 12. A CrMoW alloy second seed layer 13 having a thickness of 5 nm, a CrMo alloy underlayer 14 having a thickness of 3 nm, and a CoCr alloy nonmagnetic intermediate layer 15 having a thickness of 1 nm were successively formed on the NiP first seed layer 12. A CoCrPt₂Ta alloy first ferromagnetic layer 16 having a thickness of 4 nm, a Ru first nonmagnetic coupling layer 18 having a thickness of 0.3 nm, a CoCrPt₁₆B alloy second ferromagnetic layer 19 having a thickness of 1.5 nm, a Ru second nonmagnetic coupling layer 20 having a thickness of 0.8 nm, a CoCrPt₁₂B alloy magnetic layer 21 having a thickness of 17 nm, and a diamond-like carbon protection layer 22 having a thickness of 4.5 nm were successively formed on the CoCr alloy nonmagnetic intermediate layer 15. The layers 12 through 16 and 18 through 22 were formed by use of a DC magnetron sputtering apparatus. A lubricant layer 23 was formed by AM3001 manufactured by Ausimonoto (terminal functional group: benzene ring) to a thickness of 1.0 nm on the diamond-like carbon protection layer 22 by dipping.

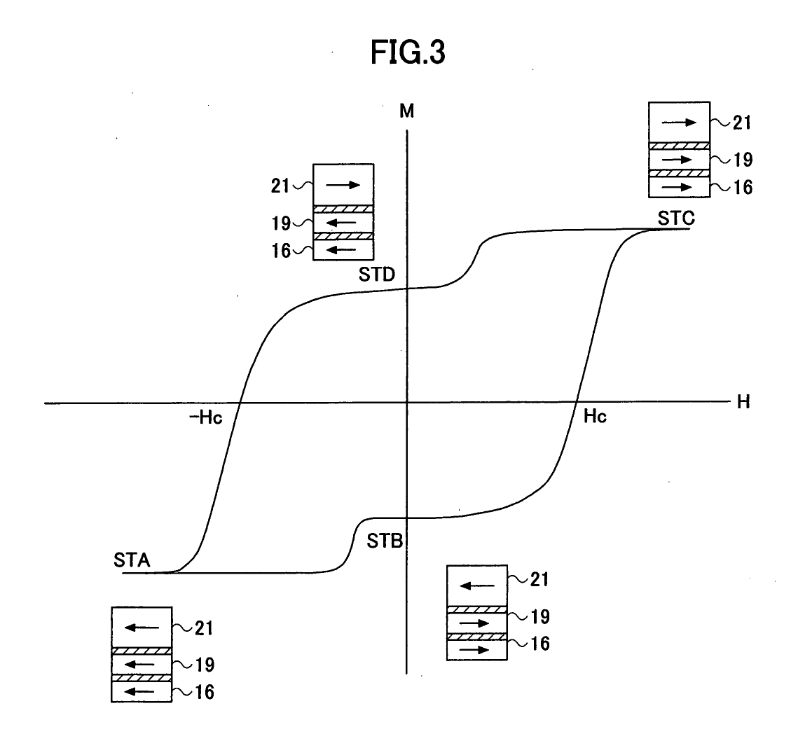

FIG. 3 is a diagram showing a static magnetic characteristic and magnetization states of the first embodiment of the magnetic recording medium. In FIG. 3, the ordinate indicates the magnetization M in arbitrary units, and the abscissa indicates the external magnetic field H in arbitrary units.

As shown in FIG. 3, when the external magnetic field H is increased from the remanent magnetization state, from a state STB to a state STC or, from a state STD to a state STA, the magnetization directions of the first ferromagnetic layer 16, the second ferromagnetic layer 19 and the magnetic layer 21 become aligned in the direction of the applied external magnetic field H and become mutually parallel. Then, when the external magnetic field H is decreased, the magnetization direction of the second ferromagnetic layer 19 switches due to the exchange field of the magnetic layer 21, and the magnetization direction of the first ferromagnetic layer 16 switches due to the exchange field of the second ferromagnetic layer 19. In a state STB or STD where no external magnetic field H is applied, the magnetization directions of the magnetic layer 21 and the second ferromagnetic layer 19 become mutually antiparallel, and the magnetization directions of the first ferromagnetic layer 16 and the second ferromagnetic layer 19 become mutually parallel. Furthermore, when the direction of the external magnetic field H is switched and the external magnetic field H is increased, the magnetization direction of the magnetic layer 21 starts to switch, and the net magnetization M of the 3 layers 16, 19 and 21 becomes 0, thereby making the value of the external magnetic field H the coercivity Hc of the 3 layers 16, 19 and 21. The static magnetic characteristic is measured by a Vibration Sample Magnetometer (VSM) or the like, and the measuring time of one loop is on the order of approximately several minutes. The time required to switch the direction of the external magnetic field H is on the order of approximately several seconds. As mentioned above, such a time required to switch the direction of the external magnetic field H will hereinafter be referred to as the “magnetic field switching time”, and the coercivity Hc for the case where the magnetic field switching time is on the order of seconds or greater is referred to as the static coercivity Hc.

The static magnetic characteristic for the case where the time required to switch the direction of the external magnetic field H is on the order of approximately several seconds is approximately the same for the magnetic recording medium 10 of this embodiment and the conventional magnetic recording medium having the magnetic layer with the single-layer structure in place of the exchange-coupled structure.

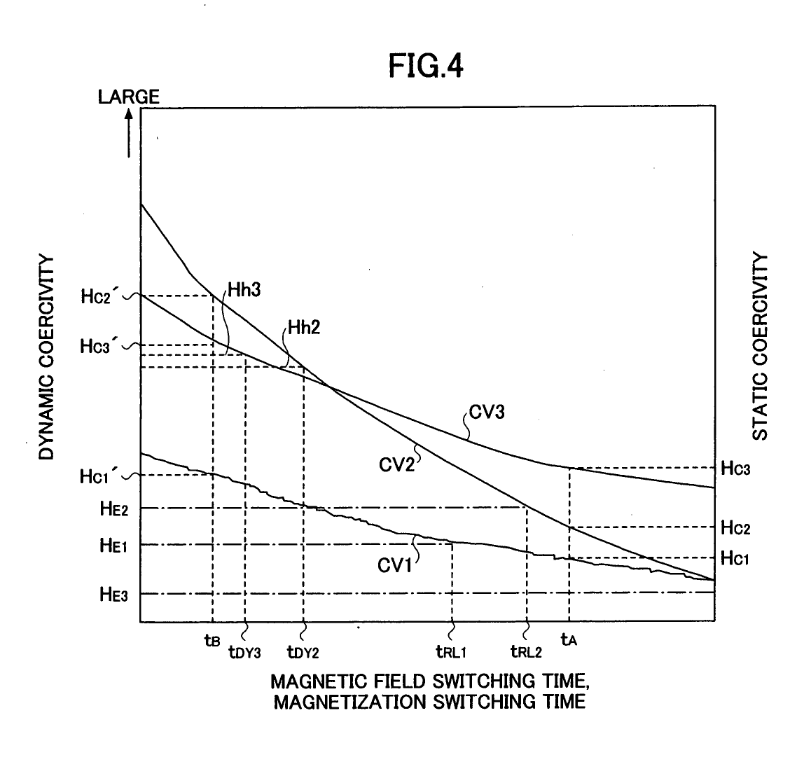

FIG. 4 is a diagram showing relationships of the dynamic coercivity and the static coercivity, and the magnetic field switching time and the magnetization switching time of the first embodiment of the magnetic recording medium. The magnetization switching time refers to a time required to switch the magnetization direction. In FIG. 4, the left ordinate indicates the dynamic coercivity in arbitrary units, the right ordinate indicates the static coercivity in arbitrary units, and the abscissa indicates the magnetic field switching time and the magnetization switching time in arbitrary units.

On the other hand, the magnetic field switching time at the time of the recording when the magnetic head applies the magnetic field on the magnetic recording medium 10 is on the sub-nano-second to approximately one nano-second order. When switching the magnetic field in such a short magnetic field switching time, a force (for example, a viscous force) acts in the direction interfering with the magnetization motion, and a large magnetic field needs to be applied in order to switch the magnetization direction. In other words, the coercivity Hc increases, and this coercivity Hc which increases in such a manner is referred to as the dynamic coercivity Hc′.

FIG. 4 shows a coercivity characteristic curve CV1 of the first ferromagnetic layer 16, a coercivity characteristic curve CV2 of the second ferromagnetic layer 19, and a coercivity characteristic curve CV3 of the magnetic layer 21. As shown in FIG. 4, in the magnetic recording medium 10 of this embodiment, the static coercivities Hc1, Hc2 and Hc3 of the first ferromagnetic layer 16, the second ferromagnetic layer 19 and the magnetic layer 21 are small during a magnetic field switching time tA which is on the order of approximately several seconds. On the other hand, the dynamic coercivities Hc1′, Hc2′ and Hc3′ of the first ferromagnetic layer 16, the second ferromagnetic layer 19 and the magnetic layer 21 are large during a magnetic field switching time tB which is on the sub-nano-second to approximately one nano-second order.

It is preferable for the static coercivities Hc1, Hc2 and Hc3 of the first ferromagnetic layer 16, the second ferromagnetic layer 19 and the magnetic layer 21 to satisfy relationships Hc3>Hc2 and Hc3>Hc1 during the magnetic field switching time tA, because the magnetic layer 21 can bear the net remanent magnetization and thickness product. That is, the magnetization transition region can be formed in the magnetic layer 21 in correspondence with the switching position of the recording magnetic field of the magnetic head.

On the other hand, it is preferable for the dynamic coercivities Hc1′, Hc2′ and Hc3′ of the first ferromagnetic layer 16, the second ferromagnetic layer 19 and the magnetic layer 21 to satisfy a relationship Hc1′<Hc3′≦Hc2′ during the magnetic field switching time tB. For example, in a case where the applied recording magnetic field and exchange field (including the directions) are approximately the same for each of the first ferromagnetic layer 16, the second ferromagnetic layer 19 and the magnetic layer 21, the magnetization switching time is shortest for the first ferromagnetic layer 16, second shortest for the magnetic layer 21, and longest for the second ferromagnetic layer 19. Accordingly, when the recording magnetic field is switched, the magnetization direction of the first ferromagnetic layer 16 switches first, the magnetization direction of the magnetic layer 21 switches second, and the magnetization direction of the second ferromagnetic layer 19 switches last. In the case of the magnetic recording medium 10 of this embodiment, the magnetization direction of the magnetic layer 21 is easily switched due to the action of the exchange field.

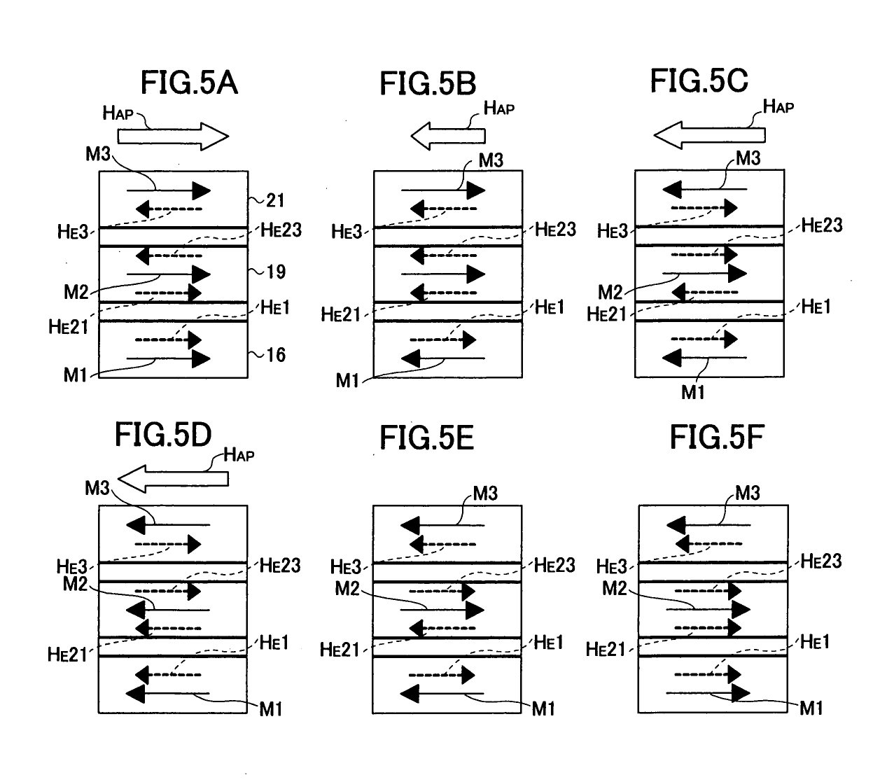

Next, a description will be given of a first embodiment of a recording method according to the present invention, by referring to FIGS. 5A through 5F. FIGS. 5A through 5F are diagrams for explaining this first embodiment of the recording method according to the present invention. For the sake of convenience, FIGS. 5A through 5F show only a part of the magnetic recording medium 10, and it is also assumed that the magnetic head and the magnetic recording medium 10 are stationary relative to each other. Further, the illustration of the magnetic head is omitted in FIGS. 5A through 5F.

FIG. 5A shows a state where a recording magnetic field HAP from the magnetic head is applied in a rightward direction as indicated by a large arrow, and a magnetization M1 of the first ferromagnetic layer 16, a magnetization M2 of the second ferromagnetic layer 19 and a magnetization M3 of the magnetic layer 21 are all magnetized in the rightward direction, as indicated by solid arrows.

FIG. 5B shows a state where the recording magnetic field HAP is switched in a leftward direction as indicated by a large arrow, and the magnetization M1 of the first ferromagnetic layer 16 having the lowest dynamic coercivity Hc1′ is switched in the leftward direction by the recording magnetic field HAP before the magnetizations M2 and M3 of the second ferromagnetic layer 19 and the magnetic layer 21, as indicated by solid arrows. In this state, the first ferromagnetic layer 16 and the magnetic layer 21 are respectively exchange-coupled to the second ferromagnetic layer 19. For this reason, an exchange field HE21 of the first ferromagnetic layer 16 and an exchange field HE23 of the magnetic layer 21 are applied to the second ferromagnetic layer 19 in parallel to the recording magnetic field HAP, as indicated by dotted arrows. In addition, an exchange field HE3 of the second ferromagnetic layer 19 is applied to the magnetic layer 21 in parallel to the recording magnetic field HAP, as indicated by a dotted arrow. The magnetization M3 of the magnetic layer 21 switches in the direction of the recording magnetic field HAP before the magnetization M2 of the second ferromagnetic layer 19 when the following relationship is satisfied, where Hh2 denotes a magnitude of the recording magnetic field HAP at the second ferromagnetic layer 19 and Hh3 denotes a magnitude of the recording magnetic field HAP at the magnetic layer 21.
Hh3+HE3−Hc3′>Hh2+HE2−Hc2′>0

FIG. 5C shows a state after a slight time has elapsed from the state shown in FIG. 5B. In this state, the magnetization M3 of the magnetic layer 21 has switched in the direction of the recording magnetic field HAP. By increasing the recording magnetic field HAP, the magnetization M2 of the second ferromagnetic layer 19 switches as shown in FIG. 5D. As a result, in the state shown in FIG. 5D, the magnetizations M1, M2 and M3 of the first ferromagnetic layer 16, the second ferromagnetic layer 19 and the magnetic layer 21 become mutually parallel. Further, in the magnetic layer 21, a magnetization transition region, which is a boundary between the previously formed magnetization in the rightward direction, is formed at the timing with which the magnetization M3 of the magnetic layer 21 is switched in FIG. 5C.

FIG. 5E shows a state after the recording magnetic field HAP is removed. The direction of the magnetization M2 of the second ferromagnetic layer 19 is switched by magnetization attempt due to the exchange fields HE21 and HE23 applied thereto. A time required for the magnetization M2 of the second ferromagnetic layer 19 to switch direction is indicated as a magnetization switching time tRL2 shown in FIG. 4, which satisfies the following relationship with respect to the exchange field HE2 (=|HE23−HE21|) and the dynamic coercivity Hc2′.
|HE23−HE21|≧Hc2′

The magnetization switching time tRL2 is a time region between the magnetic field switching times tA and tB, and it is preferable that the magnetization switching time tRL2 is as short as possible. Due to an exchange field HE1 of the second ferromagnetic layer 19 which is applied to the first ferromagnetic layer 16, the magnetization M1 of the first ferromagnetic layer 16 requires a magnetization switching time tRL1 shown in FIG. 4 to switch direction.

FIG. 5F shows a remanent magnetization state after the direction of the magnetization M1 of the first ferromagnetic layer 16 is switched. In this state, the magnetizations M1 and M2 of the first and second ferromagnetic layers 16 and 19 are antiparallel with respect to the magnetization M3 of the magnetic layer 21.

Accordingly, the magnetization M3 of the magnetic layer 21 switches direction before the magnetization M2 of the second ferromagnetic layer 19, due to the recording magnetic field HAP which is intensified by the exchange field HE3 of the second ferromagnetic layer 19. Moreover, it is possible to positively switch the directions of the magnetizations M1 and M2 of the first and second ferromagnetic layers 16 and 19 to become antiparallel with respect to the direction of the magnetization M3 of the magnetic layer 21 after the recording magnetic field HAP is removed.

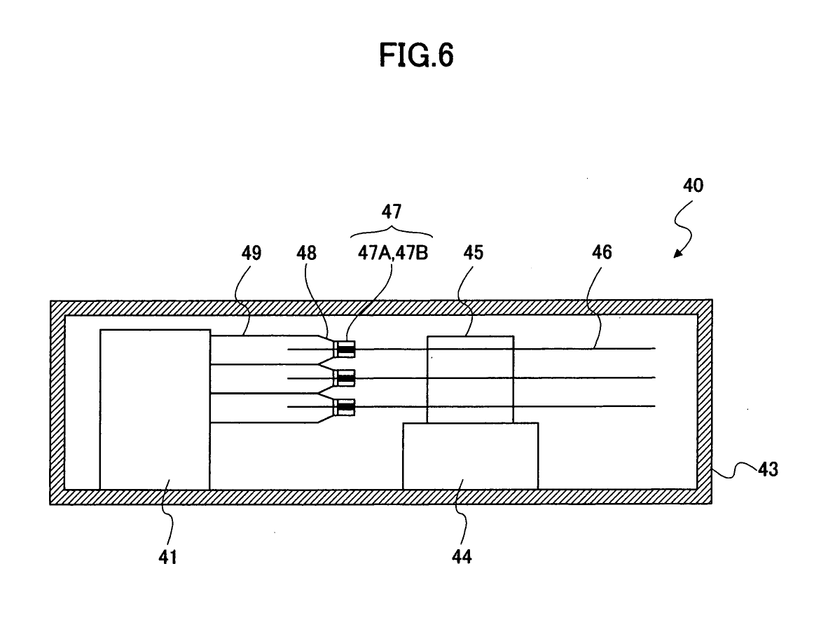

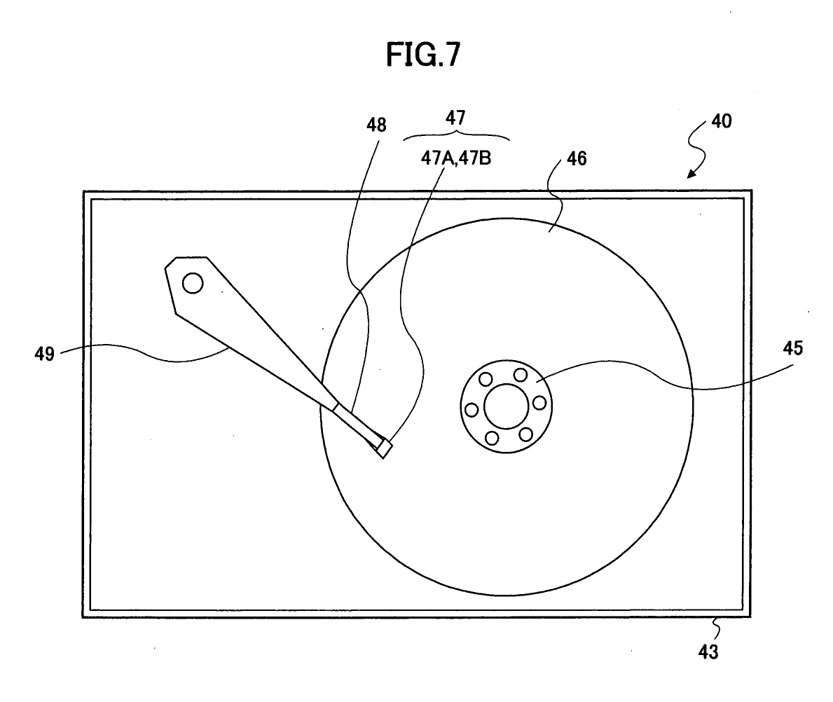

FIG. 6 is a cross sectional view showing a part of a first embodiment of a magnetic storage apparatus according to the present invention, and FIG. 7 is a plan view showing a part of the first embodiment of the magnetic storage apparatus. This embodiment of the magnetic storage apparatus employs an embodiment of a recording method according to the present invention, to record information on the embodiment of the magnetic recording medium described above.

As shown in FIGS. 6 and 7, a magnetic storage apparatus 40 generally includes a housing 43. A motor 44, a hub 45, a plurality of magnetic recording media 46, a plurality of recording and reproducing heads (composite heads) 47, a plurality of suspensions 48, a plurality of arms 49, and an actuator unit 41 are provided within the housing 43. The magnetic recording media 46 are mounted on the hub 45 which is rotated by the motor 44. The recording and reproducing head 47 is made up of a reproducing head 47A and a recording head 47B. For example an Magneto-Resistive (MR) element, a Giant Magneto-Resistive (GMR) element, a Tunneling Magneto-Resistive (TMR) element, a Current Perpendicular to Plane (CPP) element and the like may be used as the reproducing head 47A. On the other hand, an inductive head such as a thin film head may be used for the recording head 47B. Each recording and reproducing head 47 is mounted on the tip end of a corresponding part 49 via the suspension 48. The arms 49 are moved by the actuator unit 41. The basic construction of this magnetic storage apparatus is known, and a detailed description thereof will be omitted in this specification.

The magnetic storage apparatus 40 is characterized by the magnetic recording media 46. Each of the magnetic recording media 46 has the stacked structure of the embodiment of the magnetic recording medium described above in conjunction with FIGS. 2 through 5. In other words, each of the magnetic recording media 46 may have the structure of the magnetic recording medium 10 shown in FIG. 2. Of course, the number of magnetic recording media 46 is not limited to 3, and only 1, 2 or 4 or more magnetic recording media 46 may be provided.

The basic construction of the magnetic storage apparatus is not limited to that shown in FIGS. 6 and 7. In addition, the magnetic recording medium 46 used in the present invention is not limited to a magnetic disk. For example, the magnetic recording medium 46 may be a magnetic tape. When using the magnetic tape as the magnetic recording medium 46, the magnetic storage apparatus may be formed by a helical scan type video tape recording and/or reproducing apparatus or, a magnetic tape apparatus for computers which forms a plurality of tracks in a direction taken along the width of the magnetic tape.

According to the magnetic storage apparatus 40, it is possible to carry out a highly reliable high-density recording, because each magnetic recording medium 46 has satisfactory write performances, a satisfactory thermal stability of written bits and low medium noise.

Further, the present invention is not limited to these embodiments, but various variations and modifications may be made without departing from the scope of the present invention.

1. A magnetic recording medium comprising:
a first ferromagnetic layer;
a first nonmagnetic coupling layer disposed on the first ferromagnetic layer;
a second ferromagnetic layer disposed on the first nonmagnetic coupling layer;
a second nonmagnetic coupling layer disposed on the second ferromagnetic layer; and
a magnetic layer disposed on the second nonmagnetic coupling layer,
said first and second ferromagnetic layers being exchange-coupled,
said second ferromagnetic layer and said magnetic layer being exchange-coupled,
said first and second ferromagnetic layers having magnetizations which are mutually parallel in a state where no external magnetic field is applied thereto,
said second ferromagnetic layer and said magnetic layer having magnetizations which are mutually antiparallel in the state where no external magnetic field is applied thereto,
said first and second ferromagnetic layers and said magnetic layer respectively having dynamic coercivities Hc1′, Hc2′ and Hc3′ which satisfy a relationship Hc1′<Hc3′≦Hc2′ in a switching time region of a recording magnetic field.

2. The magnetic recording medium as claimed in claim 1, wherein said second ferromagnetic layer has a Pt content greater than that of said magnetic layer.

3. The magnetic recording medium as claimed in claim 1, wherein said second ferromagnetic layer has a thickness in a range of 0.2 nm to 3.0 nm.

4. The magnetic recording medium as claimed in claim 1, wherein said second ferromagnetic layer has an anisotropic field greater than that of said first ferromagnetic layer.

5. The magnetic recording medium as claimed in claim 1, wherein said second nonmagnetic coupling layer has a thickness greater than that of the first nonmagnetic coupling layer.

6. The magnetic recording medium as claimed in claim 1, wherein each of said first and second nonmagnetic coupling layers is selected from a group consisting of Ru, Rh, Ir, Ru alloy, Rh alloy and Ir alloy.

7. The magnetic recording medium as claimed in claim 1, wherein said first nonmagnetic coupling layer is made of Ru and has a thickness in a range of 0.1 nm to 0.45 nm.

8. The magnetic recording medium as claimed in claim 1, wherein said first nonmagnetic coupling layer is made of RuCo and has a thickness in a range of 0.1 nm to 0.95 nm.

9. The magnetic recording medium as claimed in claim 1, wherein said second nonmagnetic coupling layer is made of Ru and has a thickness in a range of 0.5 nm to 0.9 nm.

10. The magnetic recording medium as claimed in claim 1, wherein said first and second ferromagnetic layers and said magnetic layer satisfy a relationship (Ms1×t1+Ms2×t2)<(Ms3×t3), where Ms1 and t1 respectively denote a saturation magnetization and a thickness of said first ferromagnetic layer, Ms2 and t2 respectively denote a saturation magnetization and a thickness of said second ferromagnetic layer, and Ms3 and t3 respectively denote a saturation magnetization and a thickness of said magnetic layer.

11. A magnetic recording medium comprising:
a first ferromagnetic layer;
a first nonmagnetic coupling layer disposed on the first ferromagnetic layer;
a second ferromagnetic layer disposed on the first nonmagnetic coupling layer;
a second nonmagnetic coupling layer disposed on the second ferromagnetic layer; and
a magnetic layer disposed on the second nonmagnetic coupling layer,
said first and second ferromagnetic layers being exchange-coupled,
said second ferromagnetic layer and said magnetic layer being exchange-coupled,
said first and second ferromagnetic layers having magnetizations which are mutually parallel in a state where no external magnetic field is applied thereto,
said second ferromagnetic layer and said magnetic layer having magnetizations which are mutually antiparallel in the state where no external magnetic field is applied thereto,
said first ferromagnetic layer being made of a CoCr alloy or a CoCrPt alloy,
said second ferromagnetic layer and said magnetic layer being made of a CoCrPt alloy,
said first and second ferromagnetic layers and said magnetic layer respectively having Pt contents Pt1, Pt2 and Pt3 satisfying a relationship Pt1<Pt3≦Pt2.

12. The magnetic recording medium as claimed in claim 11, wherein said second ferromagnetic layer has a Pt content greater than that of said magnetic layer.

13. The magnetic recording medium as claimed in claim 11, wherein said second ferromagnetic layer has a thickness in a range of 0.2 nm to 3.0 nm.

14. The magnetic recording medium as claimed in claim 11, wherein said second ferromagnetic layer has an anisotropic field greater than that of said first ferromagnetic layer.

15. The magnetic recording medium as claimed in claim 11, wherein said second nonmagnetic coupling layer has a thickness greater than that of the first nonmagnetic coupling layer.

16. The magnetic recording medium as claimed in claim 11, wherein each of said first and second nonmagnetic coupling layers is selected from a group consisting of Ru, Rh, Ir, Ru alloy, Rh alloy and Ir alloy.

17. The magnetic recording medium as claimed in claim 11, wherein said first nonmagnetic coupling layer is made of Ru and has a thickness in a range of 0.1 nm to 0.45 nm.

18. The magnetic recording medium as claimed in claim 11, wherein said first nonmagnetic coupling layer is made of RuCo and has a thickness in a range of 0.1 nm to 0.95 nm.

19. The magnetic recording medium as claimed in claim 11, wherein said second nonmagnetic coupling layer is made of Ru and has a thickness in a range of 0.5 nm to 0.9 nm.

20. The magnetic recording medium as claimed in claim 11, wherein said first and second ferromagnetic layers and said magnetic layer satisfy a relationship (Ms1×t1+Ms2×t2)<(Ms3×t3), where Ms1 and t1 respectively denote a saturation magnetization and a thickness of said first ferromagnetic layer, Ms2 and t2 respectively denote a saturation magnetization and a thickness of said second ferromagnetic layer, and Ms3 and t3 respectively denote a saturation magnetization and a thickness of said magnetic layer.

21. A magnetic recording medium comprising:
a first ferromagnetic layer;
a first nonmagnetic coupling layer disposed on the first ferromagnetic layer;
a second ferromagnetic layer disposed on the first nonmagnetic coupling layer;
a second nonmagnetic coupling layer disposed on the second ferromagnetic layer; and
a magnetic layer disposed on the second nonmagnetic coupling layer,
said first and second ferromagnetic layers being exchange-coupled,
said second ferromagnetic layer and said magnetic layer being exchange-coupled,
said first and second ferromagnetic layers having magnetizations which are mutually parallel in a state where no external magnetic field is applied thereto,
said second ferromagnetic layer and said magnetic layer having magnetizations which are mutually antiparallel in the state where no external magnetic field is applied thereto,
a magnetization direction of said magnetic layer switching before a magnetization direction of said second ferromagnetic layer when a recording magnetic field for switching the magnetization direction of said magnetic field is applied to the magnetic recording medium.

22. A magnetic storage apparatus comprising:
at least one magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, said first and second ferromagnetic layers being exchange-coupled, said second ferromagnetic layer and said magnetic layer being exchange-coupled, said first and second ferromagnetic layers having magnetizations which are mutually parallel in a state where no external magnetic field is applied thereto, said second ferromagnetic layer and said magnetic layer having magnetizations which are mutually antiparallel in the state where no external magnetic field is applied thereto, said first and second ferromagnetic layers and said magnetic layer respectively having dynamic coercivities Hc1′, Hc2′ and Hc3′ which satisfy a relationship Hc1′<Hc3′≦Hc2′ in a switching time region of a recording magnetic field; and
a head to record information on and/or reproduce information from the magnetic recording medium.

23. A magnetic storage apparatus comprising:
at least one magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, said first and second ferromagnetic layers being exchange-coupled, said second ferromagnetic layer and said magnetic layer being exchange-coupled, said first and second ferromagnetic layers having magnetizations which are mutually parallel in a state where no external magnetic field is applied thereto, said second ferromagnetic layer and said magnetic layer having magnetizations which are mutually antiparallel in the state where no external magnetic field is applied thereto, said first ferromagnetic layer being made of a CoCr alloy or a CoCrPt alloy, said second ferromagnetic layer and said magnetic layer being made of a CoCrPt alloy, said first and second ferromagnetic layers and said magnetic layer respectively having Pt contents Pt1, Pt2 and Pt3 satisfying a relationship Pt1<Pt3≦Pt2; and
a head to record information on and/or reproduce information from the magnetic recording medium.

24. A magnetic storage apparatus comprising:
at least one magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, said first and second ferromagnetic layers being exchange-coupled, said second ferromagnetic layer and said magnetic layer being exchange-coupled, said first and second ferromagnetic layers having magnetizations which are mutually parallel in a state where no external magnetic field is applied thereto, said second ferromagnetic layer and said magnetic layer having magnetizations which are mutually antiparallel in the state where no external magnetic field is applied thereto, a magnetization direction of said magnetic layer switching before a magnetization direction of said second ferromagnetic layer when a recording magnetic field for switching the magnetization direction of said magnetic field is applied to the magnetic recording medium; and
a head to record information on and/or reproduce information from the magnetic recording medium.

25. A recording method for magnetically recording information on a magnetic recording medium by applying a recording magnetic field on the magnetic recording medium, said magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, said first and second ferromagnetic layers being exchange-coupled, said second ferromagnetic layer and said magnetic layer being exchange-coupled, said first and second ferromagnetic layers having magnetizations which are mutually parallel in a state where no external magnetic field is applied thereto, said second ferromagnetic layer and said magnetic layer having magnetizations which are mutually antiparallel in the state where no external magnetic field is applied thereto, said recording method comprising the steps of:
switching a magnetization direction of the magnetic layer; and
switching magnetization directions of the first and second ferromagnetic layers by applying the recording magnetic field to make the magnetizations of the first and second ferromagnetic layers mutually parallel and thereafter removing the recording magnetic field.

26. A recording method for magnetically recording information on a magnetic recording medium by applying a recording magnetic field on the magnetic recording medium, said magnetic recording medium comprising a first ferromagnetic layer, a first nonmagnetic coupling layer disposed on the first ferromagnetic layer, a second ferromagnetic layer disposed on the first nonmagnetic coupling layer, a second nonmagnetic coupling layer disposed on the second ferromagnetic layer, and a magnetic layer disposed on the second nonmagnetic coupling layer, said first and second ferromagnetic layers being exchange-coupled, said second ferromagnetic layer and said magnetic layer being exchange-coupled, said first and second ferromagnetic layers having magnetizations which are mutually parallel in a state where no external magnetic field is applied thereto, said second ferromagnetic layer and said magnetic layer having magnetizations which are mutually antiparallel in the state where no external magnetic field is applied thereto, said recording method comprising the steps of:
switching a magnetization direction of the magnetic layer; and
satisfying a relationship Hh3+HE3−Hc3′>Hh2+HE2−Hc2′>0 when switching a direction of the recording magnetic field, where Hc2′ denotes a dynamic coercivity of the second ferromagnetic layer, Hc3′ denotes a dynamic coercivity of the magnetic layer, HE2 denotes an exchange field applied to the second ferromagnetic layer due to exchange fields of the first ferromagnetic layer and the magnetic layer, HE3 denotes an exchange field of the second ferromagnetic layer applied to the magnetic layer, Hh2 denotes a recording magnetic field at the second ferromagnetic layer, and Hh3 denotes a recording magnetic field at the magnetic layer.

27. The recording method as claimed in claim 26, further comprising the steps of:
satisfying a relationship |HE23−HE21|≧Hc2′ after removing the recording magnetic field, where H23 denotes an exchange field of the magnetic layer applied to the second ferromagnetic layer, and HE21 denotes an exchange field of the first ferromagnetic layer applied to the second ferromagnetic layer.

28. A magnetic recording medium comprising:
a first ferromagnetic layer;
a first nonmagnetic coupling layer disposed on the first ferromagnetic layer;
a second ferromagnetic layer disposed on the first nonmagnetic coupling layer;
a second nonmagnetic coupling layer disposed on the second ferromagnetic layer; and
a magnetic layer disposed on the second nonmagnetic coupling layer,
said first and second ferromagnetic layers being exchange-coupled and having mutually parallel magnetizations,
said second ferromagnetic layer and said magnetic layer being exchange-coupled and having magnetizations which are mutually antiparallel,
said first and second ferromagnetic layers and said magnetic layer respectively having dynamic coercivities Hc1′, Hc2′ and Hc3′ which satisfy a relationship Hc1′<Hc3′≦Hc2′ in a switching time region of a recording magnetic field.
